(19) United States
(12) Patent Application Publication
(10) Pub. No.: US 2025/0384276 A1
(43) Pub. Date: Dec. 18, 2025

(54) PROPAGATION GUIDING

(71) Applicant: QUALCOMM Incorporated, San Diego, CA (US)

(72) Inventors: Jamie Menjay LIN, San Diego, CA (US); Jisoo JEONG, San Diego, CA (US); Fatih Murat PORIKLI, San Diego, CA (US)

(21) Appl. No.: 18/746,674

(22) Filed: Jun. 18, 2024

(51) Int. Cl. G06N 3/084

(52) U.S. Cl. CPC G06N 3/084

(57) ABSTRACT

Certain aspects of the present disclosure provide techniques for guiding a propagation process in a machine learning model. Such techniques may include inputting a set of features, a set of current estimates, and at least one propagation conditioning term into a machine-learning model, wherein the at least one propagation conditioning term is configured to guide the propagation process; and outputting, by the machine-learning model, based on the input, an updated set of estimates.

### INTRODUCTION

### Field of the Disclosure

Aspects of the present disclosure relate to machine-learning, and more particularly, to techniques for guiding a propagation process in a machine learning model.

### Description of Related Art

Machine learning models, and more specifically, machine-learning based propagation methods, such as forward propagation, belief propagation, message passing, and graph neural networks, may be used to process and analyze data for a wide range of applications, including image analysis, stereo matching, object detection, and node classification. Forward propagation involves passing input data through a neural network to yield output predictions, while belief propagation is an algorithm that spreads probabilities across a graph to estimate the marginal probabilities of its variables. Message passing facilitates the exchange of information between the nodes of a graph, enabling the iterative update of node states based on the states of adjacent nodes. Graph neural networks (GNNs) are a category of deep learning models designed to handle graph-structured data by leveraging the relationships between nodes to learn representations and make predictions.

These propagation methods may pass information, features, or beliefs through layers of a neural network, such as convolutional neural networks (CNNs), GNNs, and recurrent neural networks (RNNs). In some aspects, the propagation methods utilize structured data in the form of graphs or grids, where nodes represent variables or entities and edges indicate dependencies or relationships. However, these techniques may be affected by challenges such as data uncertainties, noise, and outliers, and they might not always account for known constraints or prior knowledge, which can impact their performance.

For instance, stereo matching tasks may ignore physical constraints like the requirement for disparities to be non-negative and to maintain left-right consistency. In applications using graphs, not adjusting the flow of information based on node significance, edge reliability, or specific domain constraints could lead to the propagation of inaccuracies, resulting in less optimal outcomes and inefficient resource use. Taking disparity estimation as an example, an example propagation process can include a function that takes a feature set F (from one or multiple images) for estimation, a state S representing latent variables such as velocity, position, or other factors influencing the disparity calculation, and current estimates of the pixel-wise disparity e (often a matrix or tensor for dense or sparse estimates), and generates an output for an estimate update Δd that can be applied to the most recent estimates. This can be mathematically expressed as Δe=argmax α (F, S, e), such that e=e+Δe, where (·) represents an affinity function deriving a similarity measure for downstream tasks like stereo depth. In such an example, the propagation might exceed theoretical or predefined limits that are related to the data's physical or logical boundaries and may fail to take into account the probabilistic nature of such estimation.

In the context of graph neural networks, treating nodes and edges equally during propagation can miss critical differences among them. This approach may ignore uncertainties and fail to recognize the varying importance of nodes and edges, which can undermine the accuracy and reliability of the predictions or decisions made by these models.

Moreover, existing propagation-based methods often rely on random initialization or heuristic-based initialization strategies, which may not effectively capture the underlying distribution of the data or incorporate prior knowledge about the problem domain. This can lead to suboptimal performance, slower convergence, and increased sensitivity to noise or outliers. For instance, in stereo matching, initializing the disparity estimates with random values or a constant value may not reflect the typical disparity range or the spatial dependencies between neighboring pixels. Similarly, in graph neural networks, initializing node embeddings or edge weights without considering the graph structure or node attributes may limit the model's ability to effectively propagate information and learn meaningful representations.

### SUMMARY

One aspect provides a method for guiding a propagation process in a machine learning model. In some aspects, the method may comprise: inputting a set of features, a set of current estimates, and at least one propagation conditioning term into a machine-learning model, wherein the at least one propagation conditioning term is configured to guide the propagation process; and outputting, by the machine-learning model, based on the input, an updated set of estimates.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a system for guiding a propagation process in a machine learning model in accordance with examples of the present disclosure.

FIG. 2 depicts additional details of an example system for guiding a propagation process in a machine learning model, in accordance with examples of the present disclosure.

FIG. 3 depicts details of a propagation stage and propagation guide for guiding a propagation process in a machine learning model, in accordance with examples of the present disclosure.

FIG. 4 depicts details of a propagation stage and propagation guide for guiding a propagation process in a machine learning model, in accordance with examples of the present disclosure.

FIG. 5 depicts an example system for performing training and guiding a propagation process in a machine learning model, in accordance with examples of the present disclosure.

FIG. 6 illustrates an example artificial intelligence (AI) architecture that may be used for AI-enhanced wireless communications.

FIG. 7 illustrates an example AI architecture of a first wireless device that is in communication with a second wireless device.

FIG. 8 illustrates an example artificial neural network.

FIG. 9 depicts an example method for performing a graphics texture reconstruction.

FIG. 10 depicts aspects of an example device.

### DETAILED DESCRIPTION

Aspects of the present disclosure provide apparatuses, methods, processing systems, and computer-readable mediums for guiding a propagation process in a machine learning model.

Aspects of the present disclosure are directed to techniques for guiding a propagation process in machine learning-based models by incorporating at least one of a learnable or non-learnable probabilistic conditioning term configured to guide a propagation process. In certain aspects, these techniques may improve model accuracy and performance in various propagation-based tasks, such as stereo matching, image segmentation, object detection, and node classification. As previously discussed, propagation-based methods may be widely used in machine learning for tasks that involve iterative refinement or information flow across data points. Such methods can rely on the exchange of information between neighboring nodes or pixels to update their states or labels. However, conventional propagation methods often suffer from limitations, such as sensitivity to noise, inability to handle uncertainties, and lack of domain-specific constraints.

In examples, certain aspects of the present disclosure can address these limitations by utilizing at least one of a probabilistic conditioning term to guide a propagation process, also referred to as “propagation conditioning.” In certain aspects, a probabilistic conditioning term provides a way to quantify the uncertainty or importance associated with different nodes, edges, or data points in a propagation process. These probabilistic conditioning terms can be learnable or non-learnable and can be based on factors such as the confidence of predictions, reliability of input data, or relevance of certain features. In certain aspects, by incorporating these probabilistic conditioning terms, a propagation process can prioritize more informative and reliable data points while reducing the influence of noisy or uncertain ones.

In accordance with some aspects, learnable probabilistic conditioning terms may be measures that can be optimized or adapted during a training process of a machine learning model. In some aspects, these terms may be parameterized by a neural network that takes the features or current estimates as input and outputs a probability distribution over possible values. By learning these terms, a machine learning model can adjust and fine-tune a propagation process based on the specific characteristics and patterns present in the data. In accordance with some aspects, non-learnable probabilistic conditioning terms may be measures that can be fixed and may be based on prior knowledge or domain- specific criteria. Such terms may not be updated during a learning process but are instead defined prior to learning and/or based on expert knowledge or domain-specific constraints. Non-learnable terms can incorporate information such as the expected range of values for the estimates or other relevant domain-specific factors.

In certain aspects, the probabilistic conditioning term can include various functions to enforce domain-specific constraints or prior knowledge in a propagation process. These functions can modulate the propagation of information based on certain criteria or rules relevant to the specific task or domain. For example, in stereo matching, a consistency function can influence the agreement between left and right disparity estimates, ensuring that estimated disparities are consistent across both views. Additionally, a range limiting function can be used to restrict the disparity values within a plausible range based on the expected scene geometry. In graph-based tasks, such as node classification or link prediction, a node attribute function can control the propagation based on the attributes or features associated with each node. This allows the propagation process to prioritize or suppress the influence of certain nodes based on their characteristics. Similarly, an edge weight function can modulate the propagation based on the weights or strengths of the connections between nodes, giving more importance to strongly connected nodes.

In certain aspects, at least one probabilistic conditioning term can be integrated into a learning process of a machine-learning model. During training, the machine-learning model can learn to optimize probabilistic conditioning term(s) based on a task-specific objective function, allowing the machine-learning model to adapt to the characteristics of the data and a desired behavior of the propagation process. In certain aspects, such integration can enable the machine-learning model to learn a (e.g., optimal) way of incorporating the probabilistic conditioning term(s) for improved performance.

In certain aspects, the incorporation of learnable or non-learnable probabilistic conditioning term(s) provides several advantages over traditional propagation method. For example, the use of learnable or non-learnable probabilistic conditioning term(s) can improve the ability for a machine-learning model's to handle uncertainties, prioritize informative data points, and/or enforce domain-specific constraints, thereby providing more accurate and reliable predictions. Moreover, the use of probabilistic conditioning term(s) can be adapted to various propagation-based tasks and may be compatible with different machine learning architectures, such as GNNs, CNNs, and RNNs.

In certain aspects, techniques described herein may be implemented across one or more domains, such as computer vision, natural language processing, and/or graph-based learning. To illustrate the application of the proposed propagation method, techniques described herein can be applied to the example of disparity estimation in stereo matching. At least one aim of disparity estimation is to determine the pixel-wise correspondence between a pair of stereo images to estimate depth information. In this context, probabilistic conditioning term(s) can be employed to improve the accuracy and consistency of the disparity estimates. A damping function is used as an example probabilistic conditioning term, but another type of probabilistic conditioning term could similarly be used according to the aspects discussed herein. For example, a consistency function could be used to enforce agreement between the left and right disparity estimates. This function could ensure that the estimated disparities are consistent across both stereo views, improving the overall coherence of the depth information. Another example could be a range limiting function that could restrict the disparity values within a plausible range based on the expected scene geometry. Such a function could prevent the propagation of unrealistic or physically impossible disparity estimates, thereby improving the accuracy of the results.

Mathematically, the probabilistic propagation for disparity estimation can be expressed as:

$$Δ e = arg max ( F , S , e , C ) \qquad Equation l$$

where C can represent either a learnable or non-learnable probabilistic conditioning term given the current disparity estimates e, such as a damping function indicating the “headroom” availability against boundary constraints. The function α represents the affinity or similarity measure between the feature set F and the current state S. Thus, in one example, a damping function d can be defined as the “headroom to the boundary” and expressed as:

$$d = M - e \qquad Equation 2$$

where d may be a damping field tensor providing dense or semi-dense constraints, M may be a standard mesh grid function, understandable from the uni-directional disparity of the rectified right image and subtractable from the corresponding left image, and e represents the current disparity estimate or displacement. The incorporation of the damping function d in the propagation process helps to enforce consistency and limit the disparity estimates to a reasonable range. By considering the “headroom” between the current estimate and the boundary, a disparity estimation model can adapt its propagation behavior to avoid violating domain-specific constraints.

In certain aspects, a probabilistic condition term, such as the example damping function, can be applied to specific targets within the propagation process to enforce constraints, guide information flow, or control the influence of certain components. Example targets (e.g., damping targets) can include, but are not limited to: local or global cost volume; disparity features; and loss functions.

A cost volume may represent the aggregated costs or distances associated with different disparity hypotheses in stereo matching or other correspondence implementations. By applying a probabilistic condition term, such as the damping function, to the cost volume during learning and inference, techniques described herein can enforce consistency constraints, limit the range of considered disparities, and/or prioritize more reliable correspondence estimates.

Disparity features may refer to learned or extracted features from the input stereo images or intermediate representations within the model that encode information about the estimated disparities or correspondences. In examples, learned features may refer to the representations that are learned by a machine learning model, such as a convolutional neural network, during a training process. Such features may not be explicitly defined by a user but may instead be learned by the model based on the patterns and characteristics present in the training data. The model can adjust its internal parameters to capture the most relevant and discriminative information for the task at hand. In the case of disparity estimation, learned features could include high-level abstractions that encode information about edges, textures, or semantic cues that are useful for determining the correspondence between pixels in stereo images. In some aspects, extracted features may refer to the representations that are explicitly computed or derived from the input data using predefined algorithms or techniques. These features may be handcrafted and designed based on domain knowledge and understanding of the specific task. Extracted features may not be learned by the model but rather provided as input to the model. Examples of extracted features for disparity estimation could include edge maps, texture descriptors, or other low-level image properties that are believed to be informative for establishing pixel correspondences.

As an example, in a convolutional neural network for stereo matching, disparity features could be the activations of a specific layer that capture relevant information for disparity estimation, such as edge, texture, or semantic cues. By applying probabilistic condition term, such as the damping function, to these disparity features, techniques described herein can modulate the influence of these disparity features based on their reliability, consistency, or adherence to domain-specific constraints. This can help to propagate more accurate and consistent disparity information throughout the model. For example, if a particular disparity feature is deemed unreliable due to low texture or occlusion, the damping function can reduce its influence on the propagation process, prioritizing more reliable features.

Loss functions can measure discrepancies between the predicted disparities and the ground truth values during training. Incorporating a probabilistic condition term, such as the damping function, into the loss function can serve as a regularization term, encouraging a network to learn disparity estimates that comply with the specified constraints or prior knowledge. Such an approach can guide the learning process towards more consistent and physically plausible disparity predictions.

In certain aspects, the choice of target may depend on specific requirements and characteristics of a given application, where experimenting with different targets or combining multiple targets can help to identify an effective strategy for the given application. For example, in the context of stereo matching, applying the probabilistic condition term, such as the damping function to both the cost volume and disparity features may be more effective than applying the probabilistic condition term to either component alone. In certain aspects, using the loss function as the sole target may be less effective, as it may only affect the learning process and may not directly influence propagation during inference.

In certain aspects, the learning of the probabilistic conditioning term(s) can be integrated into an overall training process of a machine learning model. The model parameters can be optimized to minimize a task-specific loss function, which takes into account the accuracy of the disparity estimates and the consistency enforced by the probabilistic conditioning term(s). In some aspects, the incorporation of probabilistic conditioning term(s) leads to performance gains when compared to traditional propagation-based methods.

Certain aspects of the present disclosure are directed to techniques for guiding a propagation process in machine learning-based models by incorporating one or more propagation conditioning terms, such as one or more of a damping function, accelerating function, directional function, or the like. These propagation conditioning term(s) can modulate the flow of information during the propagation process, allowing the model to adapt to the specific characteristics and requirements of the task at hand. For example, a damping function can be used to suppress or slow down the propagation in certain areas, such as regions with high uncertainty or noise, while an accelerating function can encourage or speed up the propagation in other areas, such as regions with strong semantic consistency or reliable estimates. A directional function can promote propagation along specific directions, such as along object boundaries or motion trajectories, while restricting propagation in irrelevant or unlikely directions. In certain aspects, by incorporating these propagation conditioning term(s), the techniques described herein may provide the technical benefit of improved accuracy, efficiency, and/or interpretability of the propagation process.

Some aspects of the present disclosure are directed to techniques for performing probabilistic initialization in a propagation-based machine learning method, such as stereo matching, optical flow estimation, and/or node classification in graph neural network(s). Such techniques may provide the technical benefit of more informed and reliable initial estimates for the propagation process by incorporating prior knowledge, learned priors, or data-dependent statistics.

In certain aspects, probabilistic initialization can be achieved by learning a probability distribution over the initial estimates based on training data. This learned prior distribution can then capture the statistical properties and dependencies of the estimates, such as the typical range, spatial correlations, or conditional probabilities given certain features or contextual information. During inference, the initial estimates may be sampled from this learned prior distribution. For example, in the context of stereo matching, the learned prior distribution can be a joint distribution over the disparity estimates that are conditioned on the input stereo images or their features. This distribution can be parameterized by a neural network that takes the stereo images as input and outputs the parameters of the distribution, such as the mean and/or variance of a Gaussian distribution or the probabilities of a categorical distribution over discrete disparity values. By sampling from this learned prior distribution, the initial disparity estimates may better reflect the underlying scene structure and the dependencies between neighboring pixels.

In some aspects, probabilistic initialization can be realized by incorporating domain-specific knowledge or heuristics into the initialization process. For instance, in stereo matching, the initial disparity estimates can be sampled from a distribution that favors smaller disparities for distant objects and larger disparities for closer objects, based on the expected depth range of the scene. This can be achieved by defining a prior distribution that assigns higher probabilities to disparity values within a certain range depending on the pixel locations or the average depth of the scene.

Similarly, in graph neural networks, the initial node embeddings can be sampled from a distribution that considers the node degrees or other graph properties that reflect the importance or influence of each node in the graph. This prior knowledge can be incorporated into an initialization process by defining a distribution that assigns higher probabilities to embeddings that are consistent with the graph structure and the node attributes.

The probabilistic initialization techniques described herein can be integrated into a training process of propagation-based machine learning models. During training, a model can learn to refine the initial estimates obtained from the probabilistic initialization, while also updating the parameters of the learned prior distribution or the heuristic-based distribution. In certain aspects, the joint optimization of the initialization and the propagation process can allow the model to adapt to the specific characteristics of the data and the problem domain.

When combined with other aspects of the present disclosure, such as probabilistic terms or damping functions, the probabilistic initialization techniques described herein may further enhance the accuracy, efficiency, and reliability of propagation-based methods.

### Example System for Guiding a Propagation Process

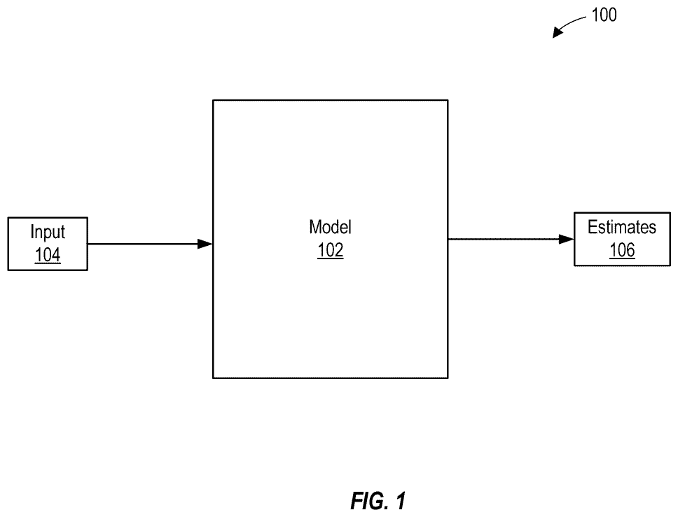

FIG. 1 illustrates a system 100 for guiding a propagation process in a machine learning model 102, in accordance with examples of the present disclosure. The system 100 may include a machine learning model 102, which can be configured to receive an input 104 and generate estimates 106 based on the input 104. In certain aspects, the system 100 further incorporates at least one propagation conditioning term that guides (e.g., bounds, such as in the case of a damping function) a propagation process within the machine learning model 102. In some examples, the at least one propagation condition term may improve the accuracy and performance of the model 102 for various propagation-based tasks. In certain aspects, a propagation-based task may refer to a class of problems in machine learning where a goal is to propagate or spread information across a structured domain, such as an image, a graph, or a sequence. These tasks often involve iterative refinement or updating of estimates based on the relationships and dependencies between different elements in the domain. A propagation process is utilized during propagation-based tasks to guide, such as control or bound, how information is propagated and how estimates may be updated over time.

Examples of propagation-based tasks include, but are not limited to stereo matching, image segmentation, object detection, post estimation, graph-based semi-supervised learning, and sequence labeling. In stereo matching, one goal is to estimate a depth or disparity map from a pair of stereo images. For example, a propagation process can involve spreading information about the correspondence between pixels in the left and right images based on their similarity and spatial proximity. The estimates can then be iteratively refined by considering consistency and smoothness constraints across neighboring pixels.

In some aspects, image segmentation aims to partition an image into meaningful regions or objects. An example propagation process in image segmentation can involve spreading information about the pixel labels or object boundaries based on the similarity and continuity of image features. The estimates may be updated by considering the contextual relationships between pixels and the high-level semantic information. In some aspects, object detection can include identifying and localizing objects of interest in an image. An example propagation process in object detection can involve spreading information about the object boundaries, bounding boxes, or class labels based on the spatial and semantic relationships between image regions. The estimates can then be refined by considering the consistency and coherence of object predictions across different scales and locations within an image.

In some aspects, pose estimation can be used to determine the configuration or layout of objects or body parts in an image. An example propagation process in pose estimation involves spreading information about the locations and orientations of keypoints or body joints based on the structural and kinematic constraints of the object or body. The estimates can then be updated by considering the consistency and plausibility of pose predictions across different parts and frames.

In graph-based semi-supervised learning, a goal can involve propagating labels from a small set of labeled nodes to a large set of unlabeled nodes in a graph. An example propagation process can involve spreading the label information across a graph based on the similarity and connectivity of the nodes. The estimates can then be updated by considering the smoothness and consistency of label assignments across neighboring nodes. In some aspects, sequence labeling tasks, such as named entity recognition or part-of-speech tagging, involves assigning labels to elements in a sequence. An example propagation process in sequence labeling can involve spreading information about the labels based on the contextual dependencies and patterns in the sequence. The estimates can then be updated by considering the consistency and coherence of label assignments across different positions and scales.

Specific details and implementations of a propagation process can vary depending on a task and the domain. However, in certain aspects, a general goal of a propagation process can be to iteratively update the estimates by spreading information across a structured domain based on the relevant relationships and constraints. In certain aspects, the system 100 addresses various limitations of conventional propagation methods, which often suffer from sensitivity to noise, inability to handle uncertainties, and lack of domain-specific constraints. By incorporating propagation conditioning terms, the system 100 can enable the machine learning model 102 to generate more accurate and reliable estimates 106, even in the presence of noisy or uncertain input data

In certain aspects, the model 102 may be implemented using various machine learning architectures, such as deep neural networks, convolutional neural networks, or recurrent neural networks, depending on the specific requirements of the propagation-based task. In certain aspects, the model 102 can be configured to receive the input 104, along with one or more propagation conditioning terms, and iteratively update its internal state to generate the estimates 106.

The input 104 can represent the data provided to the machine learning model 102 for processing. In the context of propagation-based tasks, the input 104 may include a set of features extracted from raw data, such as images, videos, or sensor readings. These features can serve as the initial state of the model 102 and provide information for the propagation process to begin. The input 104 may also include additional information, such as prior knowledge or domain-specific constraints, which can be incorporated into the propagation process through one or more propagation conditioning terms.

In certain aspects, the estimates 106 represent the output of the machine learning model 102, generated through a guided propagation process. In various embodiments, the estimates 106 may take different forms depending on the specific propagation-based task being performed. For example, in a stereo matching task, the estimates 106 may represent disparity maps that capture pixel-wise correspondence between two images. In an image segmentation task, the estimates 106 may represent segmentation masks that assign each pixel to a particular object or background class. The accuracy and quality of the estimates 106 can depend on the effectiveness of the propagation process and the incorporation of appropriate propagation conditioning terms.

For example, a propagation process can propagate information across different spatial or temporal scales, allowing the model 102 to capture both local and global context. The propagation process can also perform in challenging conditions, such as noise, occlusions, or ambiguities in the input data. The choice of appropriate model architectures, such as convolutional neural networks (CNNs) or graph neural networks (GNNs), can impact the effectiveness of the propagation process. In certain aspects, these architectures can be tailored to the specific requirements of the propagation-based task and can learn and utilize the relevant patterns and structures in the data.

In some aspects, the incorporation of appropriate propagation conditioning terms is another factor in obtaining accurate and estimates 106. A propagation conditioning term can represent additional information or constraints that can guide and modulate a propagation process. By incorporating domain-specific knowledge, constraints, or uncertainties, the propagation conditioning term can help the model to make more informed and accurate predictions.

For example, in a stereo matching task, the propagation conditioning term may include information about the camera geometry, the expected disparity range, or the presence of occlusions. By incorporating these constraints, the model 102 can avoid making physically implausible predictions and can focus on the most likely disparity values. Similarly, in an image segmentation task, the propagation conditioning term may include class-specific priors, spatial constraints, or object-level relationships. These conditioning terms help the model 102 to produce segmentations that are consistent with an underlying scene structure and the relationships between objects.

In certain aspects, by incorporating appropriate propagation conditioning terms, the accuracy and quality of the estimates 106 can be improved. Further, by providing additional guidance and constraints, the conditioning terms can help the model 102 to avoid making errors and to produce estimates that are consistent with the underlying task requirements.

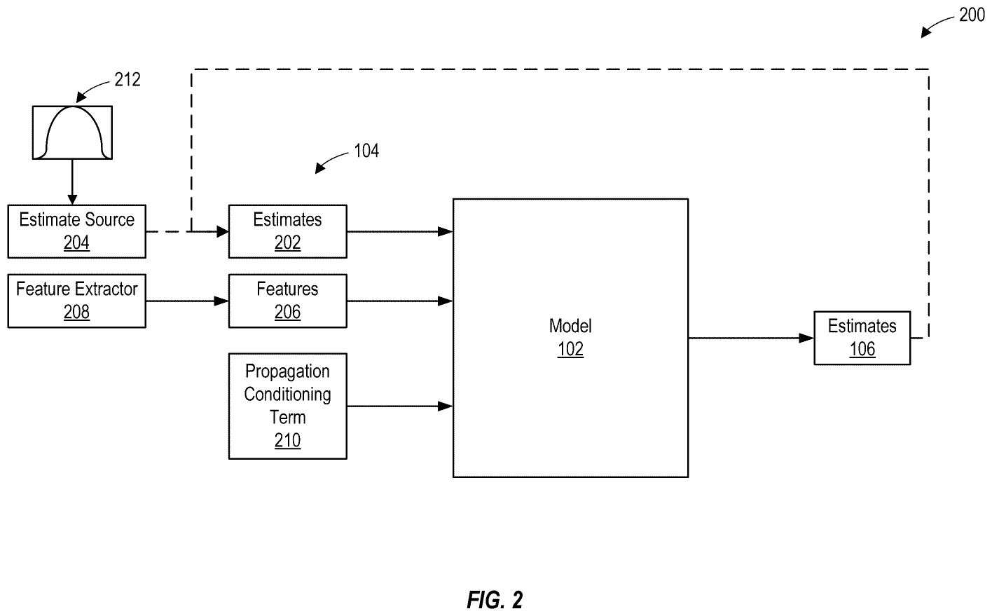

FIG. 2 depicts another example system 200 for guiding a propagation process in a machine learning model 102, in accordance with examples of the present disclosure. The system 200 can provide additional components and functionality to the system 100 (FIG. 1) to enhance a propagation process and, in some aspects, improve the quality of the estimates 106. In some aspects, by incorporating an estimate source 204, a feature extractor 208, and an initialization distribution 212, the system 200 can enable the machine learning model 102 to generate more accurate and reliable estimates 106, even in complex and dynamic environments.

In certain aspects, the estimates 106 represent the output of the machine learning model 102 in the system 200. The estimates 202 may refer to intermediate estimates that are generated by the estimate source 204 and serve as an input to the machine learning model 102. Similar to the estimates 106 described in FIG. 1, the estimates 202 may take various forms depending on the specific propagation-based task being performed. For example, in a stereo matching task, the estimates 202 may represent disparity maps that capture the pixel-wise correspondence between two images. In an image segmentation task, the estimates 202 may represent segmentation masks that assign each pixel to a particular object or background class. In certain aspects, the estimates 202 may be generated by the model 102 (e.g., as estimates 106) and may optionally serve as an input to the model 102. In certain aspects, this feedback loop allows the system 200 to iteratively refine the estimates 106 over multiple propagation cycles, leading to progressively improved results.

In certain aspects, the estimate source 204 can be a component of the system 200 that provides initial estimates or prior information to the machine learning model 102. The estimate source 204 can take various forms depending on the specific propagation-based task and available data. For example, in a stereo matching task, the estimate source 204 may be a separate model or algorithm that generates rough disparity estimates based on the input images. In examples, these initial disparity estimates can serve as a starting point for the propagation process in the model 102. As another example, in an image segmentation task, the estimate source 204 may provide coarse segmentation masks that can guide the propagation process towards more accurate and detailed segmentations.

In examples, the features 206 may represent additional information extracted from the input 104 that can aid in the propagation process. The features 206 can include a wide range of information depending on the specific propagation-based task and available data. For example, in a stereo matching task, the features 206 may include low-level image features such as edges, textures, or color information, as well as high-level semantic features such as object boundaries or depth cues. In an image segmentation task, the features 206 may include appearance features, contextual information, or spatial relationships between objects. The choice of features 206 can depend on the propagation-based task and the desired properties of the estimates 202 and/or estimates 106.

In certain aspects, the feature extractor 208 may be included in the system 200 and can extract features 206 from the input 104. In certain aspects, the feature extractor 208 can be implemented using various techniques, such as convolutional neural networks (CNNs), hand-crafted feature descriptors, or domain-specific algorithms. For example, in a stereo matching task, the feature extractor 208 may be a CNN trained to extract meaningful features from the input images that can aid in the disparity estimation process. In an image segmentation task, the feature extractor 208 may be a combination of CNNs and hand-crafted features that capture both low-level and high-level information relevant to the segmentation task.

In certain aspects, the propagation conditioning term 210 can include one or more additional inputs to the machine learning model 102 that can modulate or guide a propagation process. In examples, the propagation conditioning term 210 includes learnable or non-learnable parameters that encode domain-specific knowledge, constraints, or uncertainties. For example, in a stereo matching task, the propagation conditioning term 210 may include information about the camera geometry, the expected disparity range, or the presence of occlusions. In an image segmentation task, the propagation conditioning term 210 may include class-specific priors, spatial constraints, or object-level relationships. The propagation conditioning term 210 allows the system 200 to incorporate additional information that can guide the propagation process and improve the quality of the estimates 106.

In certain aspects, the propagation conditioning term 210 may include a function (e.g., damping function) and a target, such as a damping target. The function (e.g., damping function) can be utilized to modulate or regulate the propagation process based on certain criteria or constraints, while the target (e.g., damping target) can represent the specific component or aspect of the model 102 to which the function (e.g., damping function) is applied. The function (e.g., damping function) can be a learnable function parameterized by a neural network or a predefined function based on domain knowledge. The choice of the function (e.g., damping function) and target (e.g., damping target) can depend on the specific requirements and characteristics of the propagation-based task.

In certain aspects, the machine learning model 102 can be configured to apply the function (e.g., damping function) to the target (e.g., the damping target) at one or more stages of the propagation process. For example, in a stereo matching task, the target (e.g., damping target) can be the disparity estimates, and the function (e.g., damping function) can be applied to limit the range of disparity values based on the expected scene geometry. As another example, in an image segmentation task, the target can be one or more segmentation masks, and the function can be applied to enforce spatial consistency and smoothness constraints. By applying thefunction to the appropriate target, the model 102 can incorporate domain-specific knowledge and constraints into the propagation process.

In certain aspects, the function (e.g., damping function) can be designed to enforce a “headroom” constraint, which can be used to bound the estimates within a certain range or margin from a predefined boundary or limit. The headroom constraint can be used in tasks where the estimates are subject to physical or practical limitations. For example, in a depth estimation task, the headroom constraint can be used to ensure that the estimated depth values do not exceed the maximum possible depth range of the scene or the sensing device. The damping function can be formulated to gradually reduce the magnitude of the updates as the estimates approach a boundary, preventing them from overshooting or violating the constraints.

In examples, the headroom constraint can be expressed as a margin or buffer between the current estimate and the predefined boundary. For example, where a current estimate is “e” and the boundary as “B,” the headroom “h” can be calculated as the difference between the boundary and the current estimate: h=B-c. The function (e.g., damping function) can then scale estimate updates based on the available headroom. For example, where a simple damping function is a linear scaling factor that decreases as the headroom approaches zero: d=h/(B-A), where “A” is the minimum allowed value for the estimate. This damping function can have a value of “1” when the estimate is far from the boundary and can gradually decrease to “0” as the estimate approaches the boundary. By applying this damping function to the updates, the model 102 can bound the estimates with respect the headroom constraint and ensure the estimates remain within a desired range.

In certain aspects, the propagation conditioning term 210 may include an accelerating conditioning term. The accelerating conditioning term can be utilized to encourage or accelerate a propagation process into or around certain areas of interest in a structured domain. For example, in an image segmentation task, an accelerating conditioning term may encourage the propagation of object labels into regions with similar visual features or textures. This can help the model 102 to more quickly and accurately identify and segment objects in the image. The accelerating conditioning term can be learned from training data or designed based on domain-specific knowledge to focus the propagation process on the most relevant and informative regions.

In certain aspects, the propagation conditioning term 210 may include both a damping conditioning term and an accelerating conditioning term. The damping conditioning term can be utilized to slow down or suppress the propagation process in certain areas, while the accelerating conditioning term can be utilized to encourage or accelerate the propagation process in other areas. These two conditioning terms can have opposite effects on the propagation process and can be used together to balance the speed and accuracy of the estimates. For example, in a stereo matching task, the damping conditioning term may suppress the propagation of disparity values in occluded or textureless regions, while the accelerating conditioning term may encourage the propagation of disparity values in highly textured or edge-rich regions. By combining these two conditioning terms, the model 102 may achieve a more robust and accurate disparity estimation.

In some aspects, the damping conditioning term and the accelerating conditioning term may be applied at different stages or locations of the propagation process. For example, in a trajectory-based propagation process, such as object tracking or motion estimation, the damping conditioning term may be applied at both ends of a trajectory to suppress the propagation of uncertain or noisy estimates. The accelerating conditioning term may be applied at the middle or bottom portion of the trajectory to encourage the propagation of reliable and consistent estimates.

In some aspects, the propagation conditioning term 210 may include a directional conditioning term. The directional conditioning term may be utilized to promote or encourage the propagation process in one or more desirable directions while restricting or suppressing the propagation process in one or more undesirable directions. For example, in a pose estimation task, the directional conditioning term may promote the propagation of joint locations along the kinematic chain of the body while restricting the propagation of joint locations in anatomically impossible or unlikely directions. This can help the model 102 to produce more plausible and consistent pose estimates by incorporating prior knowledge about the structure and constraints of the human body.

In some aspects, the directional conditioning term may support uni-directional or restricted directional propagation, to promote the propagation process only in specific directions while suppressing the propagation process in other directions. This is in contrast to the damping conditioning term or the accelerating conditioning term, which may support omnidirectional propagation that affects the propagation process equally in all directions. The uni-directional or restricted directional propagation supported by the directional conditioning term may be used in tasks where there are strong prior assumptions or constraints about the expected direction of propagation. For example, in a sequence labeling task, such as part-of-speech tagging, the directional conditioning term may promote the propagation of labels from left to right along the sentence while suppressing the propagation of labels in the opposite direction.

In some aspects, the desirable directions promoted by the directional conditioning term may be determined based on the expected direction of motion in a specific application or use case associated with the propagation process. For example, in an autonomous driving application, the directional conditioning term may promote the propagation of object locations and velocities along the expected direction of motion of the vehicle, such as forward or backward, while restricting the propagation of object locations and velocities in lateral directions. Similarly, in a sports analysis application, the directional conditioning term may promote the propagation of player trajectories along the expected direction of play, such as towards the goal or basket, while restricting the propagation of player trajectories in irrelevant or unlikely directions. By incorporating domain-specific knowledge about the expected direction of motion, the directional conditioning term may help the model 102 to produce more accurate and meaningful estimates for the given application or use case.

In examples, an initialization distribution 212 may refer to a probability distribution used to initialize the estimates 202 at the beginning of the propagation process. In certain aspects, the initialization distribution 212 can be learned from training data or based on domain-specific knowledge. For example, in a stereo matching task, the initialization distribution 212 may be learned from a dataset of ground-truth disparity maps, capturing a typical distribution of disparities in real-world scenes. In an image segmentation task, the initialization distribution 212 may be based on class-specific priors or object size distributions. In aspects, by sampling from the initialization distribution 212, the system 200 can generate diverse and plausible initial estimates that can serve as a starting point for a propagation process.

In some aspects, and as described with respect to FIG. 2, the input 104 can represent the data provided to the system 200 for processing, while the model 102 may perform a propagation process and generate the estimates 106. However, in some aspects, the model 102 may receive additional inputs, such as estimates 202, the features 206, and the propagation conditioning term 210. In some aspects, the estimate 106 represent a final output of the system 200, generated by the machine learning model 102 and using a guided propagation process. The estimates 106 can be the result of iterative refinement and conditioning, based on the estimates 202 from the estimate source 204, the extracted features 206, and the propagation conditioning term 210.

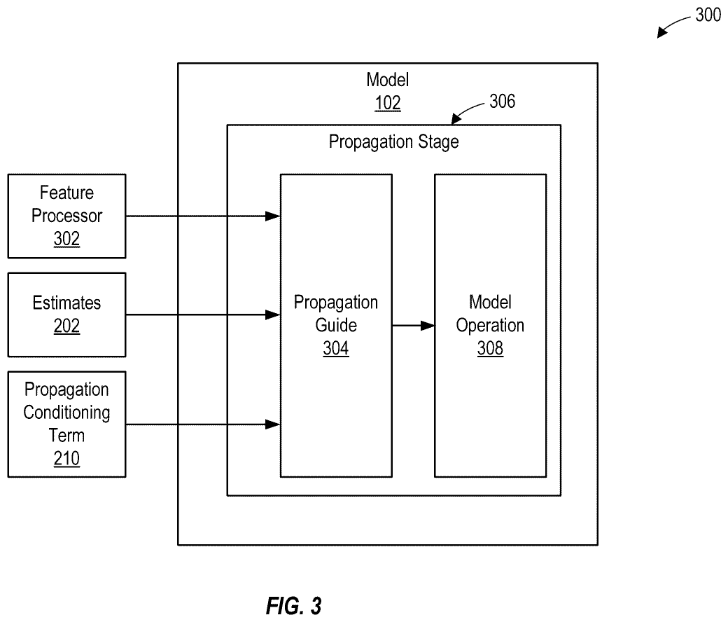

FIG. 3 illustrates another example system 300 for guiding a propagation process in a machine learning model 102, in accordance with examples of the present disclosure. In certain aspects, the system 300 can include a feature processor 302 and a propagation guide 304 that may enhance the propagation process and improve the quality of the estimates generated by the model 102. In certain aspects, the feature processor 302 may process and/or transform the input features (e.g., features 206 of FIG. 2) before they are provided to the machine learning model 102. In some examples, the feature processor 302 may perform operations such as normalization, scaling, or dimensionality reduction to provide input features that are in a suitable format for the model 102. Additionally, the feature processor 302 may apply domain-specific transformations or feature engineering techniques to extract more informative and discriminative features from the input data.

In certain aspects, the system 300 can include a propagation guide 304 that provides guidance and control over a propagation process within the machine learning model 102. The propagation guide 304 may incorporate various mechanisms, such as, but not limited to attention modules, gating functions, or conditional filters, to modulate the flow of information during a propagation process. In certain aspects, by selectively emphasizing or suppressing certain features or propagation paths, the propagation guide 304 can enable the model 102 to focus on relevant and informative aspects of the input data (e.g., input data 104, FIG. 1), leading to more accurate and, in some instances, more efficiently generated estimates.

In certain aspects, the propagation stage 306 represents a step or iteration within the overall propagation process performed by the machine learning model 102. In the system 300, the propagation process may include multiple stages 306, where each stage may be responsible for refining and updating estimates based on the input features and guidance provided by the propagation guide 304. In certain aspects, at each propagation stage 306, the model 102 may perform operations such as feature aggregation, message passing, or cross-attention to incorporate information from neighboring elements.

In certain aspects, the model operation 308 may refer to the specific computations and transformations performed by the machine learning model 102 during each propagation stage 306. In examples, these operations may include matrix multiplications, convolutions, or other mathematical functions that define the behavior of the model 102. The choice of model operations 308 can depend on the specific architecture of the model 102 and the requirements of the propagation-based task.

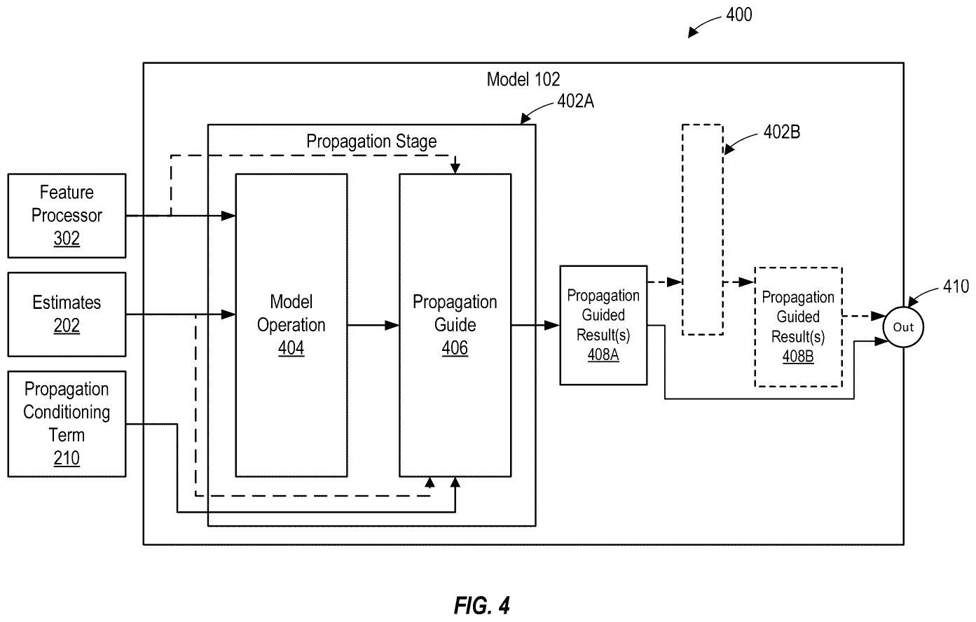

FIG. 4 depicts details of another example system 400 for guiding a propagation process in a machine learning model 102, in accordance with examples of the present disclosure. In certain aspects, the system 400 depicts details of the propagation stages 402A and 402B. In certain examples, and as previously described, the feature processor 302 can process and transform the input features before they are provided to the machine learning model 102. The estimates 202 in FIG. 4 can represent the input estimates provided to the machine learning model 102, similar to the estimates described in FIGS. 1 and 2. In certain aspects, the estimates 202 can be generated through a propagation process (e.g., as estimates 106) and may be iteratively refined based on the input features, the propagation conditioning term 210, and the guidance provided by the propagation guides within each propagation stage.

As previously described, the propagation conditioning term 210 can provide an additional input or constraint to the machine learning model 102 to modulate or guide a propagation process. The propagation conditioning term 210 may include learnable or non-learnable parameters that encode domain-specific knowledge or requirements.

In certain aspects, the model 102 can include a propagation stage 402A that may represent a specific portion or component of the machine learning model 102. In examples, within the propagation stage 402A, a model operation 404 and a propagation guide 406 can work together to process input features and generate propagation guided results 408A. In some aspects, the model operation 404 may include various computational layers or functions, such as fully connected networks, convolutional networks, or recurrent networks, depending on the specific requirements of the propagation-based task. In examples, the propagation guide 406 within the propagation stage 402A can provide guidance and control over the flow, or propagation, of information, and works to emphasize the most relevant features and suppress irrelevant ones.

In certain aspects, the propagation guided results 408A represent the output of the propagation stage 402A. The propagation guided results 408A may be generated by applying the model operation 404 and the propagation guide 406 to the input features and the propagation conditioning term 210. In certain aspects, the propagation guided results 408A may be input to satisfy or enforce certain bounds or constraints, thereby providing propagation guided results 408A that are consistent with domain-specific knowledge or requirements.

In some examples, the system 400 may include additional propagation stages, such as the propagation stage 402B. In certain aspects, the propagation stage 402B can take the propagation guided results 408A as input and apply another model operation and/or propagation guide to further refine the estimates. This can allow for a hierarchical or iterative refinement process, where the output of one propagation stage can serve as the input to the next stage.

In certain aspects, the model operation within the propagation stage 402B may include different computational layers or functions compared to the model operation 404 in the propagation stage 402A. For example, the model operation in the propagation stage 402B may include a fully connected network, a graph convolutional network, or a transformer network, depending on the specific requirements of a propagation-based task and design of the model 102. In certain aspects, the propagation guide within the propagation stage 402B may also differ from the propagation guide 406 in the propagation stage 402B, providing guidance and control specific to a refinement process.

In certain aspects, the propagation guided results 408B represent the output of the propagation stage 402B. These results can be generated by applying the model operation and propagation guide within the propagation stage 402B to the propagation guided results 408A. In certain aspects, the propagation guided results 408B may be the final output 410 of the model 102 (e.g., provided as estimates 106 of FIG. 1) or may serve as input to subsequent propagation stages, depending on the complexity of the propagation process.

In examples, the propagation stages 402A and 402B, along with their corresponding propagation guided results 408A and 408B, are illustrative examples and may be optional or modified based on the specific requirements of a propagation-based task. The number and configuration of propagation stages may vary, and the location of the propagation guides may be adjusted accordingly. For example, the propagation guide 406 may be present in both the propagation stage 402A and the propagation stage 402B, or it may be located in other propagation stages or variations thereof.

### Example Propagation Conditioning Term Training

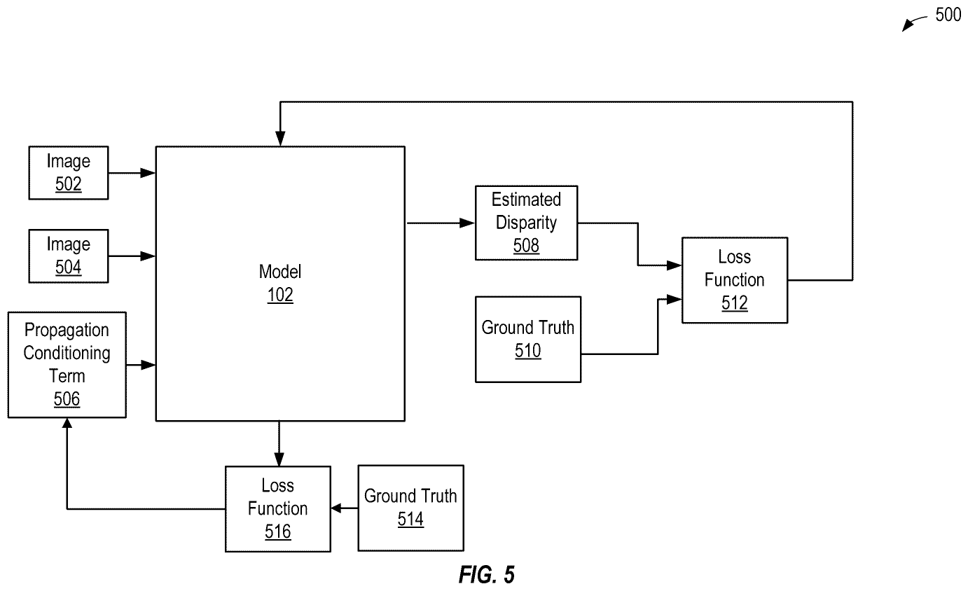

FIG. 5 depicts another example system 500 for performing training and guiding a propagation process in a machine learning model 102, in accordance with examples of the present disclosure. In certain aspects, the system 500 is directed to the application of a propagation process to the task of disparity estimation, where a goal may be to estimate the pixel-wise correspondence between two images. In examples, a training process may incorporate a learnable propagation conditioning term 506 and utilize loss functions 512 and 516 based on ground truth data. Thus, during an inference operation, the system 500 can utilize a trained model 102 to generate disparity estimates.

In certain aspects, a first image 502 and a second image 504 represent a pair of stereo images captured from slightly different viewpoints. These images can serve as an input to the machine learning model 102 for the task of disparity estimation. In some aspects, the model 102 aims to estimate the pixel-wise correspondence between the first image 502 and the second image 504, which can be used to infer the depth or 3D structure of the scene.

In certain aspects, the propagation conditioning term 506 in FIG. 5 may include a learnable component that provides additional guidance and control over a propagation process within the machine learning model 102. Unlike the fixed or a predefined propagation conditioning term, the propagation conditioning term 506 in the system 500 can be learned from data during a training process. By allowing the propagation conditioning term 506 to adapt based on the characteristics of the input images 502 and 504, and the desired disparity estimates, the system 500 may enable the model 102 to capture more complex and task-specific relationships between the images.

In examples, the model 102 takes the first image 502, the second image 504, and the learnable propagation conditioning term 506 as inputs and applies a series of operations and transformations to estimate a pixel-wise correspondence between the images. The specific architecture and operations of the model 102 may include one or more components to capture the spatial and temporal dependencies between the images while being guided by the propagation conditioning term 506.

In certain aspects, the estimated disparity 508 may represent the output of the machine learning model 102, which captures the pixel-wise correspondence between the first image 502 and the second image 504. For example, the estimated disparity 508 may encode a horizontal displacement or shift between corresponding pixels in the two images 502 and 504, which can then be used to infer the depth or 3D structure of a scene. The quality and accuracy of the estimated disparity 508 may depend on the effectiveness of the propagation process and the guidance provided by the learnable propagation conditioning term 506.

In certain aspects, the ground truth 510 and 514 can represent the true or desired disparity values for the input images 502 and 504, which are used to train and evaluate the machine learning model 102. The ground truth 510 data may be obtained through various means, such as manual annotation, depth sensors, or synthetic rendering. In examples, by comparing the estimated disparity 508 with the ground truth 510 and 514, the system 500 can assess the performance of the model 102 and provide feedback for improvement.

In some examples, the loss function 512 and 516 may be objective functions. For example, the loss function 512 may measure a discrepancy between the estimated disparity 508 and the ground truth 510. The loss functions 512 may quantify the error or difference between the predicted and true disparity values, providing a signal for the model 102 to learn and adapt one or more parameters or weights. Common loss functions for disparity estimation include, but are not limited to mean squared error or mean absolute error. By minimizing the loss function 512 during training, the system 500 may encourage the model 102 to generate more accurate and reliable disparity estimates.

In some aspects, the propagation conditioning term 506 can include a learned term or parameter; such learning may be based on ground truth 514 data. In some examples, the ground truth 514 data may be the same as or similar to the ground truth 510 data. Alternatively, or in addition, the ground truth 514 data may be specific to a propagation process occurring within the model 102. In some examples, the propagation condition term 506 can enable the model 102 to adapt to the specific characteristics and challenges associated with a propagation-based tasks, such as a disparity estimation task. In certain aspects, the propagation condition term 506 can capture relationships and dependencies between the input images 502 and 504, thereby guiding the propagation process to focus on the more informative and relevant features. During training, the parameters of the propagation conditioning term 506 can be updated along with the parameters of the model 102 to minimize the loss functions 512 and 516 and improve the quality of the estimated disparity 508. The output of the model 102 provided to the loss function 516 may be based on a propagation-based task, the propagation guide 304, or other propagation process.

### Example Artificial Intelligence System for Guiding Propagation in a Model

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an Al model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

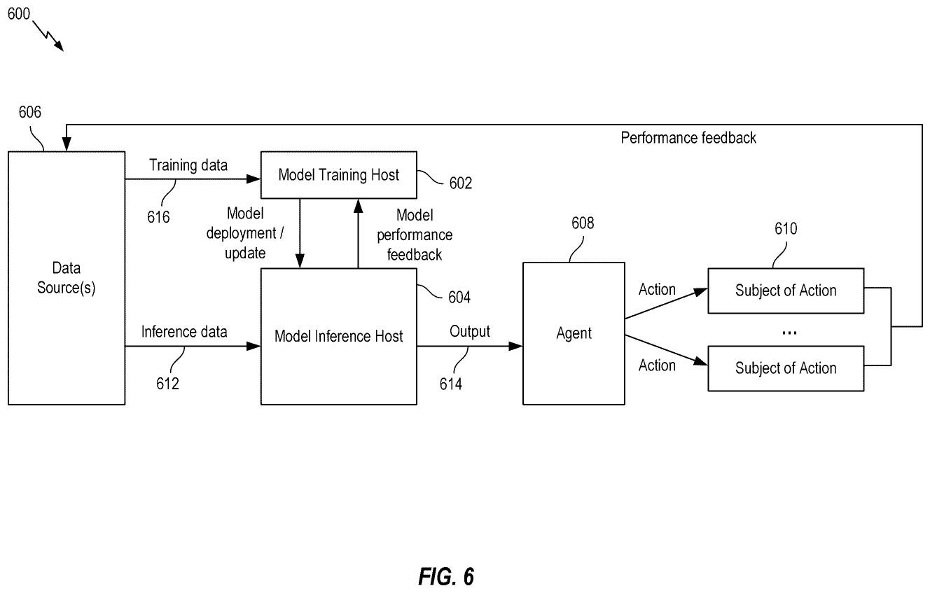

FIG. 6 is a diagram illustrating an example Al architecture 600 that may be used to implement the machine learning models and propagation techniques described in this disclosure. As illustrated, the architecture 600 includes multiple logical entities, such as a model training host 602 for training the machine learning model with damping propagation and probabilistic initialization, a model inference host 604 for running inference using the trained model, data source(s) 606 providing training and inference data, and an agent 608 that utilizes the model's output. This Al architecture could be used to enable the example disclosed propagation guidance techniques in various machine learning applications.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608.

The agent 608 may be an element or entity that utilizes the output of the machine learning model hosted by the model inference host 604. The agent 608 could be a software component, a hardware accelerator, or a system that leverages the propagation-guided estimates produced by the model for various downstream tasks such as image processing, depth estimation, or other regression and estimation problems.

For example, if the output 614 from the model inference host 604 is a refined depth estimate obtained through damping propagation, the agent 608 may be an augmented reality application that uses the depth information for rendering virtual objects. As another example, if the output 614 is an enhanced image produced by a model trained with probabilistic initialization, the agent 608 could be an image editing software.

After receiving the output 614 from the model inference host 604, the agent 608 may determine how to utilize it. For instance, if the agent 608 is an augmented reality app and the output is a depth map, it may use the depth information to occlude virtual objects behind real ones or to place virtual objects on real surfaces in a plausible manner. If the agent 608 decides to use the output 614, it may apply it to the subject of the action 610, which represents the data being processed or enhanced. In the augmented reality example, the subject of action 610 would be the rendered scene. In some cases, the agent 608 and subject of action 610 may be tightly integrated.

The data sources 606 may be configured to collect data used as training data 616 for the model training host 602 to train the propagation-guided machine learning models. The data sources 606 may also provide inference data 612 to the model inference host 604. This data could come from various entities and may include the subject of action 610. For example, for training a depth estimation model, the data sources 606 may collect stereo images and corresponding ground truth depth maps. The model training host 602 can then monitor the model's performance on this data to determine if retraining or fine-tuning with the damping propagation and probabilistic initialization techniques is necessary to improve accuracy. In some cases, the agent 608 and the subject of action 610 are the same entity.

The data sources 606 may be configured for collecting data that is used as training data 616 for training the machine learning model with damping propagation and probabilistic initialization. The data sources 606 may also provide inference data 612 (also referred to as input data) for feeding the trained model during inference. In particular, the data sources 606 may collect data relevant to the estimation task at hand, such as stereo images for depth estimation or video frames for optical flow computation. This data may come from various sources, including the subject of action 610, which represents the data being processed by the model. The collected data is provided to the model training host 602 for training and fine-tuning the propagation-guided model. For example, after the subject of action 610 (e.g., a stereo image pair) is processed by the model, the output 614 (e.g., a predicted depth map) may be compared to ground truth data to evaluate the model's performance. If the output 614 is not sufficiently accurate, this performance feedback may be used by the model training host 602 to further train the model using the disclosed propagation guidance techniques, aiming to improve its estimation accuracy. The updated model may then be deployed to the model inference host 604.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, a machine learning model utilizing damping propagation and/or probabilistic initialization is deployed at or on a computing device for enhancing the performance of estimation tasks. More specifically, a model inference host, such as model inference host 604 in FIG. 6, may be deployed at or on the computing device for running the propagation-guided model to refine estimates and improve accuracy.

In some other aspects, the propagation-enhanced machine learning model is deployed at or on an embedded system or mobile device for enabling efficient on-device inference. More specifically, a model inference host, such as model inference host 604 in FIG. 6, may be deployed at or on the embedded system or mobile device for running the model to obtain high-quality estimates while meeting resource constraints.

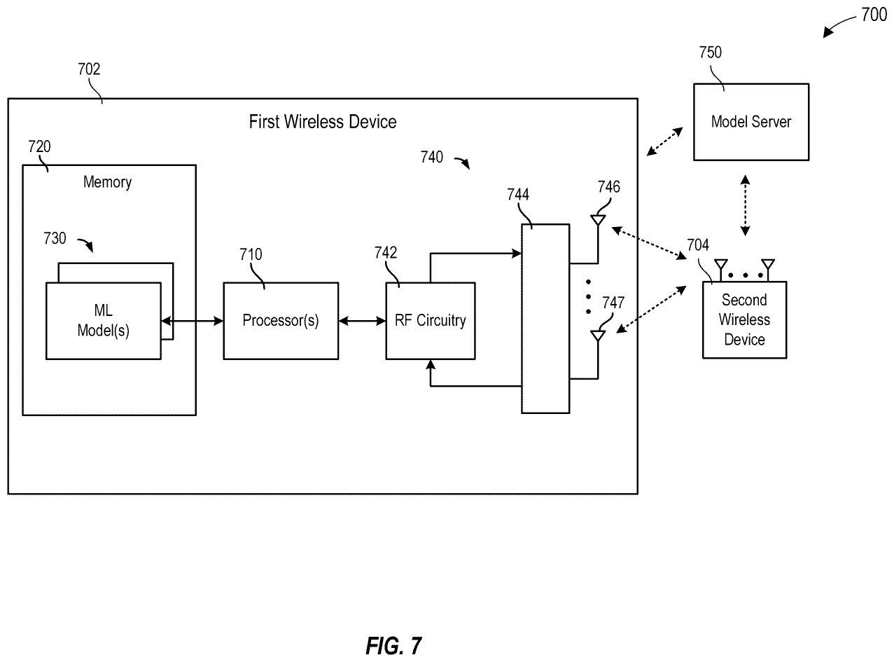

FIG. 7 illustrates an example AI architecture 700 of a first computing device 702 that is in communication with a second computing device 704. The first computing device 702 may be a server or cloud computing platform as described herein with respect to FIG. 6. Similarly, the second computing device 704 may be an embedded system or mobile device as described herein with respect to FIG. 6. Note that the AI architecture of the first computing device 702 may be applied to the second computing device 704.

The first computing device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a model inference mode, the processor 710 may transform input data (e.g., images, sensor readings) into a format suitable for the propagation-guided model. The processor 710 may then run the model on the formatted input data to generate an output estimate. The processor 710 may be coupled to a transceiver 740 for transmitting the output estimate to and/or receiving input data from one or more connected devices 746. The transceiver 740 includes interface circuitry 742 and 744 for converting between the digital signals of the processor and any transmission protocol used by the connected devices 746. The connected devices 746 may be sensors, actuators, displays, or storage that provide input to or consume the output from the model.

When receiving input data via the connected devices 746 (e.g., from the second computing device 704), the transceiver interface circuitry 742 and 744 may convert the received signals to a baseband frequency and then to digital signals for processing by the processor 710. The processor 710 may format the digital input signals and feed them into the propagation-guided model for inference.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take an incomplete or noisy estimate as input to predict a refined estimate using one or more example propagation guidance techniques previously described. The input data may include, for example, initial estimates obtained from traditional methods, such as stereo matching for depth estimation, or raw sensor measurements, such as stereo image pairs, RGB-D frames, or consecutive video frames. The output data may include, for example, a complete and accurate estimate of the desired quantity, such as a dense depth map, which is obtained by applying damping propagation and/or probabilistic initialization within the model. In certain aspects, the output estimate may be considered a “virtual” result in that it is not directly measured but rather inferred by the model based on the input observations and the learned propagation dynamics. In other cases, the output estimate may correspond to a physical quantity that is measurable in principle but not directly observed by the sensors available to the system. Note that other input data and/or output data may be used in addition to or instead of the examples described herein, depending on the specific estimation task and the available sensors.

In certain aspects, a model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first wireless device 702 and/or the second wireless device 704 to download.

In some cases, the model server 750 may monitor and evaluate the performance of the ML model 730 that utilizes damping propagation and/or probabilistic initialization to trigger one or more lifecycle management (LCM) tasks. For example, the model server 750 may determine whether to activate or deactivate the use of a particular propagation-guided model at the first computing device 702 and/or the second computing device 704, based on factors such as the accuracy requirements, computational budget, and energy constraints of each device. The model server 750 may then provide instructions to the respective devices to manage their model usage accordingly. In some cases, the model server 750 may determine whether to switch to a different variant of the propagation-enhanced ML model 730 at the first computing device 702 and/or the second computing device 704, based on changes in the operating conditions or performance objectives. For instance, the model server may instruct a device to switch from a complex model with high accuracy to a simpler model with lower latency when the battery level falls below a threshold. In yet further examples, the model server 750 may act as a central coordinator for collaborative learning of propagation-guided models across multiple devices, using techniques such as federated learning to train a global model from locally-computed updates while preserving data privacy.

### Example Artificial Intelligence Model

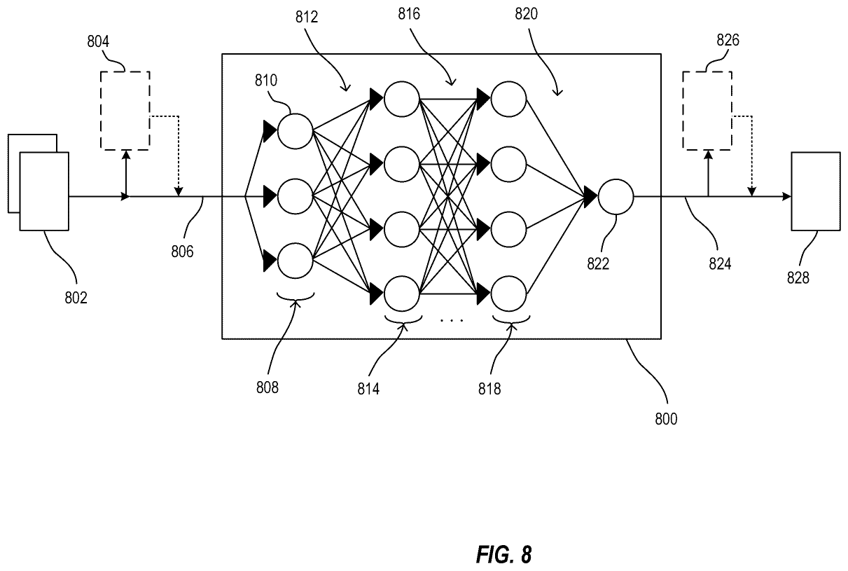

FIG. 8 is an illustrative block diagram of an example artificial neural network (ANN) 800.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 612 in FIG. 6). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration. For example, in a feedforward ANN structure each artificial neuron 810 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 800 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 800 of FIG. 8.

As part of the development process for machine learning models that utilize damping propagation and probabilistic initialization, relevant training data must be gathered or generated. For example, training data may include ground truth labels for the desired output quantities (e.g., depth maps, flow fields, segmentation masks), as well as corresponding input observations (e.g., stereo pairs, video frames, images). This data can be used to train the model to accurately propagate information and refine estimates for the given task. In certain instances, the training data may originate from sensors on user devices (e.g., smartphones, robots, vehicles), dedicated data collection equipment (e.g., multi-camera rigs, depth sensors), or public datasets. In some cases, the training data may be aggregated from multiple sources to cover a wide range of scenarios and improve model generalization. For example, crowdsourcing platforms or online databases may be leveraged to gather diverse examples for training propagation-guided models. In another example, training data may be generated synthetically using simulation engines or generative models to augment real-world samples. The training data collection process can be performed offline, resulting in a static dataset for batch training, or online, where new samples are continuously incorporated into the model training pipeline. For example, an embedded system may periodically upload new training samples gathered during operation to a server, which then fine-tunes the propagation-enhanced model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 800 of FIG. 8, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize damping propagation and probabilistic initialization on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of estimation tasks such as depth prediction or flow computation, for example, federated learning may be used to improve model performance by allowing it to learn from a wide range of environments and conditions. For instance, a propagation-enhanced depth estimation model may be trained on data collected from a large number of smartphones or autonomous vehicles, each with its own camera configuration and operating domain, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the propagation-guided model achieves satisfactory performance across all participating devices. By enabling collaborative learning while keeping data localized, federated learning allows the development of powerful propagation-based models that can leverage diverse datasets without compromising privacy or security.

In some implementations, one or more devices or services may support processes relating to the usage, maintenance, activation, and reporting of machine learning models that utilize damping propagation and probabilistic initialization. In certain instances, all or part of the training data or the trained model may be shared across multiple devices to provide or improve the estimation capabilities. For example, a smartphone with a depth sensor may share its data with a smartphone having only a single camera, enabling the latter to train a depth estimation model using propagation guidance. In some cases, signaling mechanisms may be employed to communicate the capabilities and requirements for performing specific functions related to propagation-enhanced models, such as the supported input and output formats, the available computational resources, or the ability to collect and share training data. These models may be used to support various applications, such as augmented reality, robotics, autonomous driving, or video processing, where accurate and efficient estimation of quantities like depth, flow, or segmentation is crucial. The deployment of propagation-guided models may occur at different levels of a system architecture, such as on individual devices (e.g., smartphones, vehicles), edge servers (e.g., base stations, access points), or cloud platforms, depending on factors such as latency requirements, data privacy concerns, and resource availability. By leveraging the disclosed propagation techniques, these models can provide high-quality estimates while operating under the constraints of each deployment scenario.

### Example Method for Guiding a Propagation Process

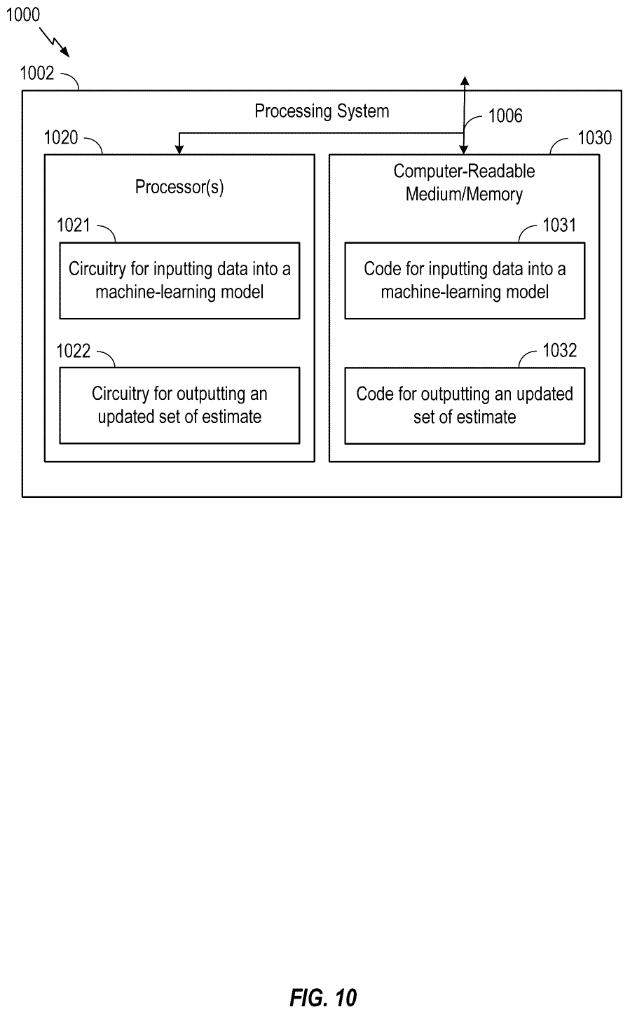

In one aspect, method 900, or any aspect related to it, may be performed by an apparatus, such as processing system 1000 of FIG. 10, which includes various components operable, configured, or adapted to perform the method 900.

Method 900 begins at 902 with inputting a set of features, a set of current estimates, and at least one propagation conditioning term into a machine-learning model. In accordance with some aspects of method 900, the at least one propagation conditioning term is configured to guide the propagation process.

The method 900 may then proceed to 904 with outputting, by the machine-learning model, and based on the input, an updated set of estimates.

In some embodiments of method 900, the propagation process is configured to be conditioned by the at least one propagation conditioning term at one or more stages of the propagation process.

In some embodiments of method 900, the one or more stages include at least one of a pre-propagation stage, an intra-propagation stage, or a post-propagation stage.

In some embodiments of method 900, the at least one propagation conditioning term comprises a damping function and a damping target, and wherein the machine learning model is further configured to apply the damping function to the damping target at one or more stages of the propagation process.

In some embodiments of method 900, the damping function is a learnable function parameterized by a neural network.

In some embodiments of method 900, the neural network is trained jointly with the machine learning model to adapt the damping function to a specific domain.

In some embodiments of method 900, the damping target represents at least one of: a local or global cost volume associated with a propagation-based task, or a set of disparity features encoding information about estimated disparities between images.

In some embodiments of method 900, a tensor representing at least one of the local or global cost volume stores matching costs between pixels in a reference image and pixels in a target image for different disparity levels.

In some embodiments of method 900, the damping target represents the set of disparity features including learned features extracted from input images, and wherein to apply the damping function to the damping target comprises to update the estimated disparities between the images.

In some embodiments of method 900, the machine-learning model is configured to perform the propagation process, wherein the propagation process is configured to generate the updated set of estimates for a propagation-based task based on the input set of features and the input set of current estimates, wherein the propagation process is configured to be conditioned by the at least one propagation conditioning term at one or more stages of the propagation process.

In some embodiments of method 900, the at least one propagation conditioning term comprises a probabilistic conditioning measure, and wherein the probabilistic conditioning measure represents at least one of: a learnable measure that quantifies uncertainty associated with at least one of the set of features or the set of current estimates, or a non-learnable measure based on at least one of prior knowledge or domain-specific criteria.

In some embodiments of method 900, the probabilistic conditioning measure is a learnable probabilistic conditioning measure that is parameterized by a neural network that is configured to: take at least one of the set of features or the set of current estimates as input; and output a probability distribution over possible values of the estimates.

In some embodiments of method 900, the probabilistic conditioning measure is a non-learnable probabilistic conditioning measure that is based on a probability distribution incorporating prior knowledge about a domain, including at least one of an expected range of values for the estimates.

In some embodiments, method 900 further includes receiving a probabilistic distribution for initializing the set of current estimates, wherein the probabilistic distribution is based on at least one of a learned prior distribution obtained from training data or a domain-specific prior distribution based on domain knowledge or problem-specific constraints; sampling a set of initial estimates from the probabilistic distribution; inputting the set of initial estimates as the set of current estimates into the machine learning model for a first iteration of the propagation process; and for subsequent iterations, setting the set of current estimates to the updated set of estimates output by the machine learning model from a previous iteration.

In some embodiments, method 900 further includes dynamically adjusting the at least one propagation conditioning term during the propagation process based on a current state of the estimates or the input set of features.

In some embodiments of method 900, a modem and one or more antennas are configured to receive the set of features.

In some embodiments of method 900, the modem and the one or more antennas are integrated into one of a vehicle, an extra-reality device, or a mobile device.

In some embodiments of method 900, the at least one propagation conditioning term comprises an accelerating conditioning term configured to increase a rate of propagation in one or more specified areas.

In some embodiments of method 900, the at least one propagation conditioning term comprises: a damping conditioning term configured to decrease a rate of propagation in the propagation process; and an accelerating conditioning term configured to increase the rate of propagation in the propagation process.

In some embodiments, method 900 further comprises: applying the damping conditioning term at a first portion of a propagation trajectory; and applying the accelerating conditioning term at a second portion of the propagation trajectory.

In some embodiments of method 900, the at least one propagation conditioning term comprises a directional conditioning term configured to modify the propagation process based on one or more directions of propagation.

In some embodiments of method 900, the directional conditioning term is configured to: increase a rate of propagation in a first direction; and decrease the rate of propagation in a second direction different from the first direction.

In some embodiments, method 900 further comprises performing propagation based on an expected direction of motion associated with an application of the propagation process.

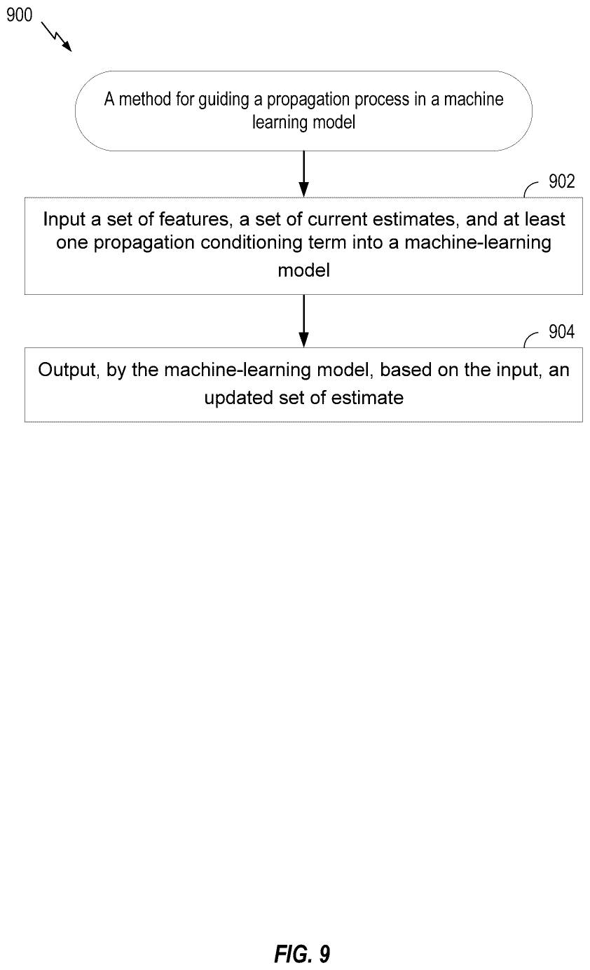

Note that FIG. 9 is just one example of a method, and other methods including fewer, additional, or alternative steps are possible consistent with this disclosure.

### Example Processing System for Guiding a Propagation Process

FIG. 10 depicts aspects of an example processing system 1000.

The processing system 1000 includes a processing system 1002 includes one or more processors 1020. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 900 described with respect to FIG. 9 or any aspect related to it, including any additional steps or sub-steps described in relation to FIG. 9.

In the depicted example, computer-readable medium/memory 1030 stores code (e.g., executable instructions) for inputting data into a machine-learning model 1031 and code for outputting an updated set of estimates 1032. Processing of the code 1031-1032 may enable and cause the processing system 1000 to perform the method 900 described with respect to FIG. 9, or any aspect related to it.

The one or more processors 1020 include circuitry configured to implement (e.g., execute) the code stored in the computer-readable medium/memory 1030, including circuitry for inputting data into a machine-learning model 1021 and circuitry for outputting an updated set of estimates 1022. Processing with circuitry 1021-1022 may enable and cause the processing system 1000 to perform the method 900 described with respect to FIG. 9, or any aspect related to it.

### Example Clauses

Implementation examples are described in the following numbered clauses:

Clause 1: A method for guiding a propagation process in a machine learning model, comprising: inputting a set of features, a set of current estimates, and at least one propagation conditioning term into a machine-learning model, wherein the at least one propagation conditioning term is configured to guide the propagation process; and outputting, by the machine-learning model, based on the input, an updated set of estimates.

Clause 2: A method in accordance with Clause 1, wherein the propagation process is configured to be conditioned by the at least one propagation conditioning term at one or more stages of the propagation process.

Clause 3: A method in accordance with Clause 2, wherein the one or more stages include at least one of a pre-propagation stage, an intra-propagation stage, or a post-propagation stage.

Clause 4: A method in accordance with any one of Clauses 1-3, wherein the at least one propagation conditioning term comprises a damping function and a damping target, and wherein the machine learning model is further configured to apply the damping function to the damping target at one or more stages of the propagation process.

Clause 5: A method in accordance with Clause 4, wherein the damping function is a learnable function parameterized by a neural network.

Clause 6: A method in accordance with Clause 5, wherein the neural network is trained jointly with the machine learning model to adapt the damping function to a specific domain.

Clause 7: A method in accordance with any one of Clauses 4-6, wherein the damping target represents at least one of: a local or global cost volume associated with a propagation-based task, or a set of disparity features encoding information about estimated disparities between images.

Clause 8: A method in accordance with Clause 7, wherein a tensor representing at least one of the local or global cost volume stores matching costs between pixels in a reference image and pixels in a target image for different disparity levels.

Clause 9: A method in accordance with any one of Clauses 7-8, wherein the damping target represents the set of disparity features including learned features extracted from input images, and wherein to apply the damping function to the damping target comprises to update the estimated disparities between the images.

Clause 10: A method in accordance with any one of Clauses 1-9, wherein the machine-learning model is configured to perform the propagation process, wherein the propagation process is configured to generate the updated set of estimates for a propagation-based task based on the input set of features and the input set of current estimates, wherein the propagation process is configured to be conditioned by the at least one propagation conditioning term at one or more stages of the propagation process.

Clause 11: A method in accordance with any one of Clauses 1-10, wherein the at least one propagation conditioning term comprises a probabilistic conditioning measure, and wherein the probabilistic conditioning measure represents at least one of: a learnable measure that quantifies uncertainty associated with at least one of the set of features or the set of current estimates, or a non-learnable measure based on at least one of prior knowledge or domain-specific criteria.

Clause 12: A method in accordance with Clause 11, wherein the probabilistic conditioning measure is a learnable probabilistic conditioning measure that is parameterized by a neural network that is configured to: take at least one of the set of features or the set of current estimates as input; and output a probability distribution over possible values of the estimates.

Clause 13: A method in accordance with Clause 11, wherein the probabilistic conditioning measure is a non-learnable probabilistic conditioning measure that is based on a probability distribution incorporating prior knowledge about a domain, including at least one of an expected range of values for the estimates.

Clause 14: A method in accordance with any one of Clauses 1-13, further comprising: receiving a probabilistic distribution for initializing the set of current estimates, wherein the probabilistic distribution is based on at least one of a learned prior distribution obtained from training data or a domain-specific prior distribution based on domain knowledge or problem-specific constraints; sampling a set of initial estimates from the probabilistic distribution; inputting the set of initial estimates as the set of current estimates into the machine learning model for a first iteration of the propagation process; and for subsequent iterations, setting the set of current estimates to the updated set of estimates output by the machine learning model from a previous iteration.

Clause 15: A method in accordance with any one of Clauses 1-14, further comprising: dynamically adjusting the at least one propagation conditioning term during the propagation process based on a current state of the estimates or the input set of features.

Clause 16: A method in accordance with any one of Clauses 1-15, wherein a modem and one or more antennas are configured to receive the set of features.

Clause 17: A method in accordance with Clause 16, wherein the modem and the one or more antennas are integrated into one of a vehicle, an extra-reality device, or a mobile device.

Clause 18: A method in accordance with any one of Clauses 1-17, wherein the at least one propagation conditioning term comprises an accelerating conditioning term configured to increase a rate of propagation in one or more specified areas.

Clause 19: A method in accordance with Clause 1, wherein the at least one propagation conditioning term comprises: a damping conditioning term configured to decrease a rate of propagation in the propagation process; and an accelerating conditioning term configured to increase the rate of propagation in the propagation process.

Clause 20: A method in accordance with Clause 19, further comprising: applying the damping conditioning term at a first portion of a propagation trajectory; and applying the accelerating conditioning term at a second portion of the propagation trajectory.

Clause 21: A method in accordance with any one of Clauses 1-20, wherein the at least one propagation conditioning term comprises a directional conditioning term configured to modify the propagation process based on one or more directions of propagation.

Clause 22: A method in accordance with Clause 21, wherein the directional conditioning term is configured to: increase a rate of propagation in a first direction; and decrease the rate of propagation in a second direction different from the first direction.

Clause 23: A method in accordance with any one of Clauses 21-22, wherein the machine learning model is configured to perform propagation based on an expected direction of motion associated with an application of the propagation process.

Clause 24: One or more apparatuses, comprising: one or more memories comprising executable instructions; and one or more processors configured to execute the executable instructions and cause the one or more apparatuses to perform a method in accordance with any one of Clauses 1-23.

Clause 25: One or more apparatuses, comprising: one or more memories; and one or more processors, coupled to the one or more memories, configured to cause the one or more apparatuses to perform a method in accordance with any one of Clauses 1-23.

Clause 26: One or more apparatuses, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured to guide a propagation process in a machine learning model, comprising:
one or more memories configured to store a set of features; and
one or more processors, coupled to the one or more memories, configured to:
input the set of features, a set of current estimates, and at least one propagation conditioning term into a machine-learning model, wherein the at least one propagation conditioning term is configured to guide the propagation process; and
output, by the machine-learning model, based on the input, an updated set of estimates.

2. The apparatus of claim 1, wherein the propagation process is configured to be conditioned by the at least one propagation conditioning term at one or more stages of the propagation process.

3. The apparatus of claim 2, wherein the one or more stages include at least one of a pre-propagation stage, an intra-propagation stage, or a post-propagation stage.

4. The apparatus of claim 1, wherein the at least one propagation conditioning term comprises a damping function and a damping target, and wherein the machine learning model is further configured to apply the damping function to the damping target at one or more stages of the propagation process.

5. The apparatus of claim 4, wherein the damping function is a learnable function parameterized by a neural network.

6. The apparatus of claim 5, wherein the neural network is trained jointly with the machine learning model to adapt the damping function to a specific domain.

7. The apparatus of claim 4, wherein the damping target represents at least one of: a local or global cost volume associated with a propagation-based task, or a set of disparity features encoding information about estimated disparities between images.

8. The apparatus of claim 7, wherein a tensor representing at least one of the local or global cost volume stores matching costs between pixels in a reference image and pixels in a target image for different disparity levels.

9. The apparatus of claim 7, wherein the damping target represents the set of disparity features including learned features extracted from input images, and wherein to apply the damping function to the damping target comprises to update the estimated disparities between the images.

10. The apparatus of claim 1, wherein the machine-learning model is configured to perform the propagation process, wherein the propagation process is configured to generate the updated set of estimates for a propagation-based task based on the input set of features and the input set of current estimates, wherein the propagation process is configured to be conditioned by the at least one propagation conditioning term at one or more stages of the propagation process.

11. The apparatus of claim 1, wherein the one or more processors are further configured to: dynamically adjust the at least one propagation conditioning term during the propagation process based on a current state of the estimates or the input set of features.

12. The apparatus of claim 1, further comprising a modem, coupled to one or more antennas, and coupled to the one or more processors, wherein the modem and the one or more antennas are configured to receive the set of features.

13. The apparatus of claim 1, wherein the at least one propagation conditioning term comprises an accelerating conditioning term configured to increase a rate of propagation in one or more specified areas.

14. The apparatus of claim 1, wherein the at least one propagation conditioning term comprises:
a damping conditioning term configured to decrease a rate of propagation in the propagation process; and
an accelerating conditioning term configured to increase the rate of propagation in the propagation process.

15. The apparatus of claim 14, wherein the machine learning model is configured to:
apply the damping conditioning term at a first portion of a propagation trajectory; and
apply the accelerating conditioning term at a second portion of the propagation trajectory.

16. The apparatus of claim 1, wherein the at least one propagation conditioning term comprises a directional conditioning term configured to modify the propagation process based on one or more directions of propagation.

17. The apparatus of claim 16, wherein the directional conditioning term is configured to:
increase a rate of propagation in a first direction; and
decrease the rate of propagation in a second direction different from the first direction.

18. The apparatus of claim 16, wherein the machine learning model is configured to perform propagation based on an expected direction of motion associated with an application of the propagation process.

19. A method for guiding a propagation process in a machine learning model, the method comprising:
inputting a set of features, a set of current estimates, and at least one propagation conditioning term into a machine-learning model, wherein the at least one propagation conditioning term is configured to guide the propagation process; and
outputting, by the machine-learning model, based on the input, an updated set of estimates.

20. A non-transitory computer-readable medium comprising instructions, which when executed by one or more processors, cause the one or more processors to perform operations for guiding a propagation process in a machine learning model, the operations comprising:
inputting a set of features, a set of current estimates, and at least one propagation conditioning term into a machine-learning model, wherein the at least one propagation conditioning term is configured to guide the propagation process; and
outputting, by the machine-learning model, based on the input, an updated set of estimates.
